(19) United States
(12) Patent Application Publication
(10) Pub. No.: US 2024/0380508 A1
(43) Pub. Date: Nov. 14, 2024

(54) Time Synchronization Method, Apparatus, and System

(71) Applicant: Huawei Technologies Co., Ltd., Shenzhen (CN)

(72) Inventor: Yongjun Liu, Shenzhen (CN)

(21) Appl. No.: 18/781,372

(22) Filed: Jul. 23, 2024

Related U.S. Application Data
(63) Continuation of application No. PCT/CN2022/143580, filed on Dec. 29, 2022.

(30) Foreign Application Priority Data
Jan. 24, 2022 (CN) 202210082465.0

(51) Int. Cl. H04J 3/06; H04W 56/00; H04W 84/12

(52) U.S. Cl. CPC H04J 3/0661; H04W 56/0015; H04W 84/12

(57) ABSTRACT

A first device receives a first message from a second device, where the first message includes a first time stamp and a second time stamp, the first time stamp is of a second WI-FI module in the second device at a first moment, and the second time stamp is a system time stamp of a second main chip in the second device at a second moment. The first device adjusts a system time of a first main chip in the first device based on the first time stamp, the second time stamp, a third time stamp, and a fourth time stamp, where the third time stamp is a time stamp of a first WI-FI module in the first device at a third moment, and the fourth time stamp is a system time stamp of the first main chip at a fourth moment.

### CROSS-REFERENCE TO RELATED APPLICATIONS

This is a continuation of International Patent Application No. PCT/CN2022/143580 filed on Dec. 29, 2022, which claims priority to Chinese Patent Application No. 202210082465.0 filed on Jan. 24, 2022. The disclosures of the aforementioned applications are hereby incorporated by reference in their entireties.

### TECHNICAL FIELD

This disclosure relates to the communication field, and in particular, to a time synchronization method, an apparatus, and a system.

### BACKGROUND

When data is processed across devices, it is usually expected that overall consumed time of a processing procedure is as short as possible. For example, in a distributed camera service scenario such as web television live broadcast or real-time monitoring, an image captured by a camera is transmitted to a screen of a television, a smartphone, or a large screen end via a network for display. If the overall consumed time of the processing procedure is greater than a specified threshold, a display image seen by a user is delayed or pauses, bringing unsmooth watching experience to the user. To locate and analyze processing phases that cause excessively high overall time consumption due to their excessively high time consumption, a system outputs, in each processing phase, log information used to analyze a time consumption status. The log information includes a time stamp obtained when data enters the processing phase and a time stamp obtained when the data leaves the processing phase, or includes a time stamp obtained when data enters the processing phase and processing duration of the data in the processing phase. In this method for analyzing consumed time of cross-device data processing based on a time stamp, system time of devices needs to be kept synchronized.

In another technology, system time of devices in a local area network is usually synchronized by using a Network Time Protocol (NTP). However, in the distributed camera service scenario, because system resources of an Internet of things (IoT) device such as a camera or a smartphone are limited and low power consumption is required, the IoT device is not suitable for enabling the NTP protocol.

### SUMMARY

Embodiments of this disclosure provide a time synchronization method, an apparatus, and a system, to improve accuracy of system time synchronization between devices in a distributed camera service scenario.

To achieve the foregoing objectives, the following technical solutions are used in embodiments of this disclosure.

According to a first aspect, a time synchronization method applied to a distributed camera service scenario is provided. An apparatus that performs the time synchronization method may be a first device, or may be a module used in the first device, for example, a chip or a chip system. The following provides descriptions by using an example in which an execution body is the first device. The first device receives a first message from a second device, where the first message includes a first time stamp and a second time stamp, the first time stamp is a time stamp of a second WI-FI module in the second device at a first moment, and the second time stamp is a system time stamp of a second main chip in the second device at a second moment. The first device adjusts system time of a first main chip in the first device based on the first time stamp, the second time stamp, a third time stamp, and a fourth time stamp, where the third time stamp is a time stamp of a first WI-FI module in the first device at a third moment, the fourth time stamp is a system time stamp of the first main chip at a fourth moment, a time difference between the first moment and the second moment is equal to a time difference between the third moment and the fourth moment, and the first WI-FI module and the second WI-FI module have implemented time synchronization before the first moment.

In the time synchronization method provided in this embodiment of this disclosure, after the first WI-FI module and the second WI-FI module implement time synchronization, the first device adjusts the system time of the first main chip in the first device based on the first time stamp, the second time stamp, the third time stamp, and the fourth time stamp. Compared with an NTP protocol used in another technology, on one hand, because of occupying less system resources and causing lower device power consumption, a WI-FI protocol may be widely applied to an IoT device. Therefore, the time synchronization method provided in this embodiment of this disclosure is more applicable to the distributed camera service scenario. On the other hand, because WI-FI module time synchronization between the first device and the second device can be implemented at a microsecond level, the time synchronization method provided in this embodiment of this disclosure can improve time synchronization accuracy.

With reference to the first aspect, in a possible implementation, before the first device receives the first message from the second device, the method further includes: the first device receives a fifth time stamp from the second device, where the fifth time stamp is a time stamp of the second WI-FI module at a fifth moment, and the fifth moment is earlier than the first moment; and the first device uses the fifth time stamp as a current time stamp of the first WI-FI module; or the first device sends a sixth time stamp to the second device, where the sixth time stamp is a time stamp of the first WI-FI module at the fifth moment.

With reference to the first aspect, in a possible implementation, that the first device adjusts system time of a first main chip in the first device based on the first time stamp, the second time stamp, a third time stamp, and a fourth time stamp includes: the first device determines, based on the first time stamp, the second time stamp, the third time stamp, and the fourth time stamp, deviation time of system time of the first device relative to system time of the second device; and if an absolute value of the deviation time is greater than a first threshold, the first device adds the deviation time to current system time, to obtain synchronized current system time of the first main chip. In this solution, the system time of the second device is used as a reference, and if there is a deviation between the system time of the first device and the system time of the second device and an absolute value of the deviation is greater than the first threshold, the system time of the first device is adjusted.

With reference to the first aspect, in a possible implementation, the deviation time is a difference obtained by subtracting a second time difference from a first time difference, the first time difference is a difference obtained by subtracting the second time stamp from the fourth time stamp, and the second time difference is a difference obtained by subtracting the first time stamp from the third time stamp.

With reference to the first aspect, in a possible implementation, the first device adds the deviation time to a system time stamp that is of the first main chip and that is collected before a current moment, to obtain a synchronized system time stamp that is of the first main chip and that is collected before the current moment. In this solution, system time synchronization may occur before data collection or during data collection, so that time synchronization flexibility can be improved. If system time synchronization occurs before data collection, the first device may correct the system time of the first device, so that data collected by the first device and data collected by the second device are subsequently based on a same time standard. If system time synchronization occurs during data collection, the first device may correct collected time data and the system time of the first device.

According to a second aspect, a communication apparatus is provided, configured to implement the foregoing method. The communication apparatus includes corresponding modules, units, or means for implementing the foregoing method. The modules, units, or means may be implemented by hardware, software, or hardware executing corresponding software. The hardware or the software includes one or more modules or units corresponding to the foregoing functions.

With reference to the second aspect, in a possible implementation, the communication apparatus is used in a distributed camera service scenario, and the communication apparatus includes a first main chip and a first WI-FI module. The first main chip is configured to receive a first message from a second device, where the first message includes a first time stamp and a second time stamp, the first time stamp is a time stamp of a second WI-FI module in the second device at a first moment, and the second time stamp is a system time stamp of a second main chip in the second device at a second moment. The first main chip is further configured to adjust system time of the first main chip in the communication apparatus based on the first time stamp, the second time stamp, a third time stamp, and a fourth time stamp, where the third time stamp is a time stamp of the first WI-FI module at a third moment, the fourth time stamp is a system time stamp of the first main chip at a fourth moment, a time difference between the first moment and the second moment is equal to a time difference between the third moment and the fourth moment, and the first WI-FI module and the second WI-FI module have implemented time synchronization before the first moment.

With reference to the second aspect, in a possible implementation, the first WI-FI module is configured to receive a fifth time stamp from the second device, where the fifth time stamp is a time stamp of the second WI-FI module at a fifth moment, and the fifth moment is earlier than the first moment; and the first WI-FI module is further configured to use the fifth time stamp as a current time stamp of the first WI-FI module; or the first WI-FI module is configured to send a sixth time stamp to the second device, where the sixth time stamp is a time stamp of the first WI-FI module at the fifth moment.

With reference to the second aspect, in a possible implementation, the first main chip is configured to: determine, based on the first time stamp, the second time stamp, the third time stamp, and the fourth time stamp, deviation time of system time of the communication apparatus relative to system time of the second device; and if an absolute value of the deviation time is greater than a first threshold, add the deviation time to current system time, to obtain synchronized current system time of the first main chip.

With reference to the second aspect, in a possible implementation, the deviation time is a difference obtained by subtracting a second time difference from a first time difference, the first time difference is a difference obtained by subtracting the second time stamp from the fourth time stamp, and the second time difference is a difference obtained by subtracting the first time stamp from the third time stamp.

With reference to the second aspect, in a possible implementation, the first main chip is further configured to add the deviation time to a system time stamp that is of the first main chip and that is collected before a current moment, to obtain a synchronized system time stamp that is of the first main chip and that is collected before the current moment.

According to a third aspect, a communication apparatus is provided, including a processor. The processor is configured to perform, after being coupled to a memory and reading computer instructions stored in the memory, the method according to the first aspect according to the instructions.

With reference to the third aspect, in a possible implementation, the communication apparatus further includes the memory. The memory is configured to store the computer instructions.

With reference to the third aspect, in a possible implementation, the communication apparatus further includes a communication interface. The communication interface is used by the communication apparatus to communicate with another device. For example, the communication interface may be a transceiver, an input/output interface, an interface circuit, an output circuit, an input circuit, a pin, or a related circuit.

With reference to the third aspect, in a possible implementation, the communication apparatus may be a chip or a chip system. When the communication apparatus is a chip system, the communication apparatus may include a chip, or may include a chip and another discrete device.

According to a fourth aspect, a computer-readable storage medium is provided. The computer-readable storage medium stores instructions, and when the instructions are run on a computer, the computer is enabled to perform the method according to the first aspect.

According to a fifth aspect, a computer program product including instructions is provided. When the computer program product runs on a computer, the computer is enabled to perform the method according to the first aspect.

According to a sixth aspect, a communication system is provided, including a first device and a second device. The second device is configured to send a first message to the first device, where the first message includes a first time stamp and a second time stamp, the first time stamp is a time stamp of a second WI-FI module in the second device at a first moment, and the second time stamp is a system time stamp of a second main chip in the second device at a second moment. The first device is configured to: receive the first message from the second device, and adjust system time of a first main chip in the first device based on the first time stamp, the second time stamp, a third time stamp, and a fourth time stamp, where the third time stamp is a time stamp of a first WI-FI module in the first device at a third moment, the fourth time stamp is a system time stamp of the first main chip at a fourth moment, a time difference between the first moment and the second moment is equal to a time difference between the third moment and the fourth moment, and the first WI-FI module and the second WI-FI module have implemented time synchronization before the first moment.

For technical effects brought by any one of the second aspect to the sixth aspect or possible implementations of the second aspect to the sixth aspect, refer to the technical effects brought by the first aspect or the different implementations of the first aspect. Details are not described herein again.

### BRIEF DESCRIPTION OF DRAWINGS

FIG. 1 is a schematic flowchart of data processing in a distributed camera service scenario in another technology.

FIG. 2 is a diagram of analyzing a time consumption status in a cross-device data processing process based on a time stamp in another technology.

FIG. 3 is a diagram of synchronizing system time by using an NTP protocol in another technology.

FIG. 4 is a diagram of an architecture of a communication system according to an embodiment of this disclosure.

FIG. 5 is a diagram 1 of a structure of a communication apparatus according to an embodiment of this disclosure.

FIG. 6 is a flowchart of a time synchronization method according to an embodiment of this disclosure.

FIG. 7 is a diagram of analyzing a time consumption status in a cross-device data processing process based on a time stamp according to this disclosure.

FIG. 8 is a diagram of a time stamp obtaining manner according to an embodiment of this disclosure.

FIG. 9 is a diagram 2 of a structure of a communication apparatus according to an embodiment of this disclosure.

### DESCRIPTION OF EMBODIMENTS

For ease of understanding the technical solutions in embodiments of this disclosure, related technologies or terms of this disclosure are first briefly described as follows:

First, data processing in a distributed camera service scenario is described.

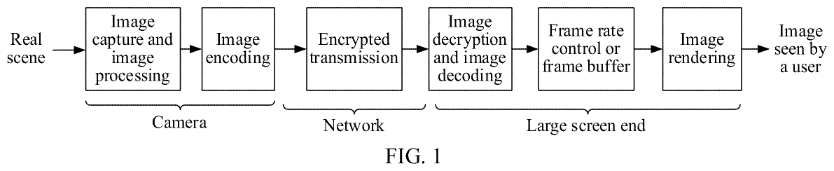

FIG. 1 shows main steps included in data processing in the distributed camera service scenario. At a camera end, image capture, image processing, and image encoding are performed on a real scene. Encoded image data is transmitted from the camera end to a large screen end via a network. At the large screen end, image decryption, image decoding, frame rate control (or frame buffer), and image rendering are performed to form an image finally seen by a user. Data processing relates to different devices, namely, a camera and the large screen end.

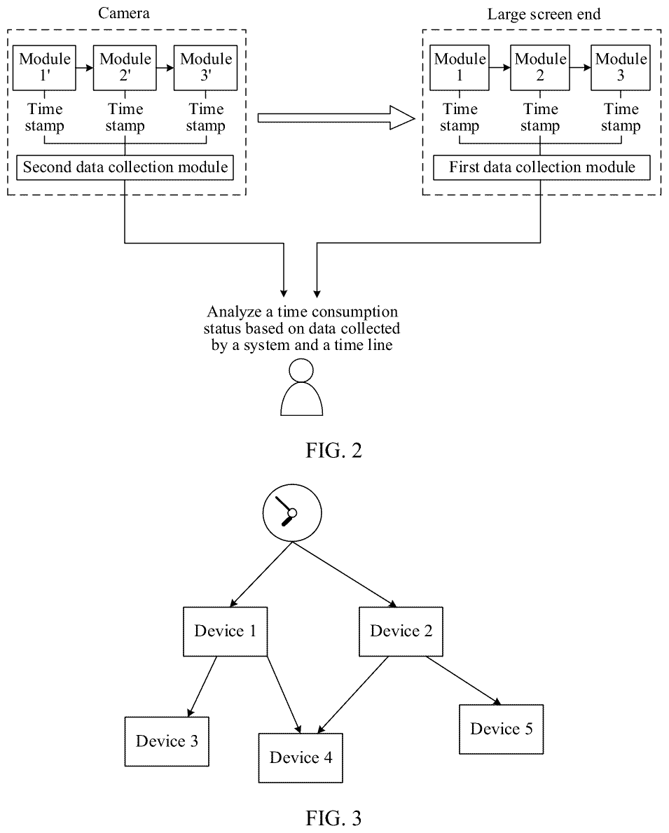

With reference to FIG. 1, FIG. 2 is a diagram of analyzing a time consumption status in a cross-device data processing process based on a time stamp. In FIG. 2, a data processing procedure of the camera end is simplified as follows: first passing through a module 1′, then passing through a module 2′, and finally passing through a module 3′; and a data processing procedure of the large screen end is simplified as follows: first passing through a module 1, then passing through a module 2, and finally passing through a module 3. It should be noted that, as an example, data processing at the camera end in FIG. 2 relates to three modules: the module 1′, the module 2′, and the module 3′. Actually, data processing at the camera end may relate to at least one module. Similarly, as an example, data processing at the large screen end in FIG. 2 also relates to three modules: the module 1, the module 2, and the module 3. Actually, data processing at the large screen end may relate to at least one module, and a quantity of modules in the camera is not necessarily equal to a quantity of modules at the large screen end. In addition, the camera further has a second data collection module, and the large screen end further has a first data collection module. As described in the background, the second data collection module may collect a time stamp obtained when data enters each of the module 1′, the module 2′, and the module 3′ and a time stamp obtained when the data leaves each of the module 1′, the module 2′, and the module 3′; and the first data collection module may collect a time stamp obtained when data enters each of the module 1, the module 2, and the module 3 and a time stamp obtained when the data leaves each of the module 1, the module 2, and the module 3. Alternatively, the second data collection module may collect a time stamp obtained when data enters each of the module 1′, the module 2′, and the module 3′ and processing duration of the data in each of the module 1′, the module 2′, and the module 3′; and the first data collection module may collect a time stamp obtained when data enters each of the module 1, the module 2, and the module 3 and processing duration of the data in each of the module 1, the module 2, and the module 3. System development or commissioning personnel analyze a time consumption status based on collected data and a time line. Provided that system time of the camera is kept synchronized with that of the large screen end, data collected in the two devices can be sorted in time sequence, so that the system development or commissioning personnel can analyze a time consumption status of each of the module 1, the module 2, the module 3, the module 1′, the module 2′, and the module 3′ based on the sorted data.

Second, an NTP protocol is described.

Usually, the NTP protocol is used to synchronize system time of devices in a local area network. The NTP protocol may use a client-server structure. A client synchronizes system time from a server, and the server synchronizes system time from an upper-layer device of the server. A top-layer device is a high-accuracy clock source. For example, as shown in FIG. 3, a device 3 and a device 4 synchronize system time from a device 1, the device 4 and a device 5 synchronize system time from a device 2, and the device 1 and the device 2 synchronize time from a same clock source. In this manner, the devices 1 to 5 in a network can basically keep system time synchronization. However, in this solution, all devices need to be connected to the network and use the NTP protocol.

On one hand, as described in the background, an IoT device is not suitable for enabling the NTP protocol. On the other hand, the NTP protocol synchronizes system time by using network hierarchy. Therefore, usually, time synchronization accuracy can only be accurate to a millisecond level. However, in some scenarios, higher-accuracy time synchronization is required. For example, in a distributed camera service scenario, provided that overall consumed time of a processing procedure is less than 200 milliseconds, a display image seen by a user is not delayed or does not pause. Therefore, a higher requirement is imposed on time synchronization accuracy.

The following describes the technical solutions in embodiments of this disclosure with reference to the accompanying drawings in embodiments of this disclosure. In the descriptions of this disclosure, unless otherwise specified, “/” indicates an “or” relationship between associated objects. For example, A/B may indicate A or B. In this disclosure, “and/or” describes only an association relationship between associated objects and indicates that three relationships may exist. For example, A and/or B may indicate the following three cases: only A exists, both A and B exist, and only B exists, where A and B may be singular or plural. In addition, in the descriptions of this disclosure, unless otherwise specified, “a plurality of” means two or more. “At least one of the following items (pieces)” or a similar expression thereof means any combination of these items, including any combination of singular items (pieces) or plural items (pieces). For example, at least one item (piece) of a, b, or c may indicate: a, b, c, a and b, a and c, b and c, or a, b, and c, where a, b, and c may be singular or plural. In addition, to clearly describe the technical solutions in embodiments of this disclosure, words such as “first” and “second” are used in embodiments of this disclosure to distinguish between same items or similar items that provide basically same functions or purposes. A person skilled in the art may understand that the words such as “first” and “second” do not limit a quantity or an execution sequence, and the words such as “first” and “second” do not indicate a definite difference. In addition, in embodiments of this disclosure, words such as “an example” or “for example” are used to indicate giving an example, an illustration, or a description. Any embodiment or design solution described as “an example” or “for example” in embodiments of this disclosure should not be explained as being more preferred or having more advantages than another embodiment or design solution. Exactly, use of the words such as “an example” or “for example” is intended to present a related concept in a specific manner, for ease of understanding.

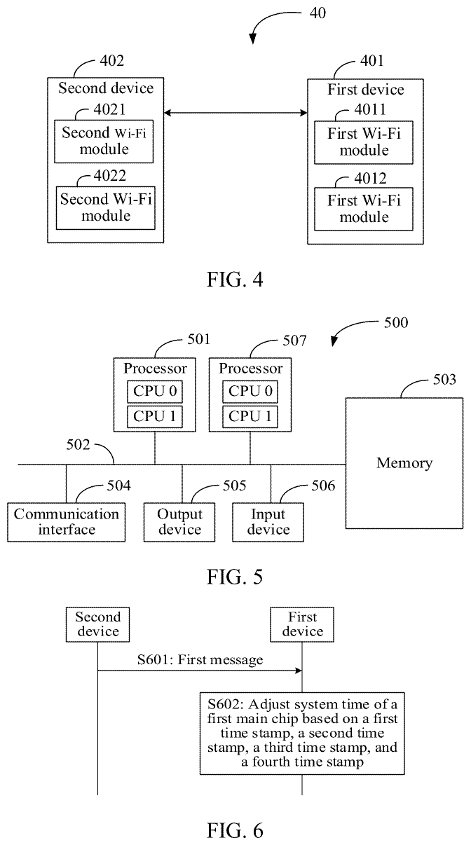

FIG. 4 shows a communication system 40 according to an embodiment of this disclosure. The communication system 40 includes a first device 401 and a second device 402. The first device 401 includes a first main chip 4011 and a first synchronous WI-FI module 4012, and the second device 402 includes a second main chip 4021 and a second WI-FI module 4022. The second device 402 is configured to send a first message to the first device 401, where the first message includes a first time stamp and a second time stamp, the first time stamp is a time stamp of the second WI-FI module 4022 in the second device at a first moment, and the second time stamp is a system time stamp of the second main chip 4021 in the second device at a second moment. The first device 401 is configured to receive the first message from the second device 402. The first device 401 is further configured to adjust system time of the first main chip 4011 in the first device based on the first time stamp, the second time stamp, a third time stamp, and a fourth time stamp, where the third time stamp is a time stamp of the first WI-FI module 4012 in the first device at a third moment, the fourth time stamp is a system time stamp of the first main chip 4011 at a fourth moment, a time difference between the first moment and the second moment is equal to a time difference between the third moment and the fourth moment, and the first WI-FI module 4012 and the second WI-FI module 4022 have implemented time synchronization before the first moment. Specific implementations and technical effects of the solution are described in detail in subsequent method embodiments, and details are not described herein.

Optionally, related functions of the first device or the second device in this embodiment of this disclosure may be implemented by one device, may be jointly implemented by a plurality of devices, or may be implemented by one or more functional modules in one device. This is not limited in this embodiment of this disclosure. It may be understood that the foregoing function may be a network element in a hardware device, or may be a software function running on dedicated hardware, a combination of hardware and software, or a virtualized function instantiated on a platform (for example, a cloud platform).

For example, the related functions of the first device or the second device in this embodiment of this disclosure may be implemented by a communication apparatus 500 in FIG. 5.

FIG. 5 is a diagram of a structure of the communication apparatus 500 according to an embodiment of this disclosure. The communication apparatus 500 includes one or more processors 501, a communication line 502, and at least one communication interface (FIG. 5 provides descriptions by using only an example in which a communication interface 504 and one processor 501 are included). Optionally, the communication apparatus may further include a memory 503.

The processor 501 may be a central processing unit (CPU), a microprocessor, an application-specific integrated circuit (ASIC), or one or more integrated circuits configured to control program execution of the solutions of this disclosure.

The communication line 502 may include a path, configured to connect different components.

The communication interface 504 may be a transceiver module, configured to communicate with another device or a communication network, for example, Ethernet, a radio access network (RAN), or a wireless local area network (WLAN). For example, the transceiver module may be an apparatus such as a transceiver. Optionally, the communication interface 504 may be a transceiver circuit located in the processor 501, and is configured to implement signal input and signal output of the processor.

The memory 503 may be an apparatus having a storage function. For example, the memory 503 may be a read-only memory (ROM) or another type of static storage device that can store static information and instructions, or a random-access memory (RAM) or another type of dynamic storage device that can store information and instructions, or may be an electrically erasable programmable read-only memory (EEPROM), a compact disc read-only memory (CD-ROM) or another compact disc storage, an optical disc storage (including a compact disc, a laser disc, an optical disc, a digital versatile disc, a BLU-RAY disc, and the like), a magnetic disk storage medium or another magnetic storage device, or any other medium that can be configured to carry or store expected program code in a form of an instruction structure or a data structure and that can be accessed by a computer, but is not limited thereto. The memory may exist independently and is connected to the processor through the communication line 502. The memory may alternatively be integrated with the processor.

The memory 503 is configured to store computer-executable instructions for executing the solutions of this disclosure, and the processor 501 controls execution of the computer-executable instructions. The processor 501 is configured to execute the computer-executable instructions stored in the memory 503, to implement the time synchronization method provided in embodiments of this disclosure.

Alternatively, in this embodiment of this disclosure, the processor 501 may perform a processing-related function in the time synchronization method provided in the following embodiments of this disclosure, and the communication interface 504 is responsible for communicating with another device or a communication network. This is not limited in this embodiment of this disclosure.

The computer-executable instructions in this embodiment of this disclosure may also be referred to as application program code. This is not limited in this embodiment of this disclosure.

During specific implementation, as an embodiment, the processor 501 may include one or more CPUs, for example, a CPU 0 and a CPU 1 in FIG. 5.

During specific implementation, as an embodiment, the communication apparatus 500 may include a plurality of processors, for example, the processor 501 and a processor 507 in FIG. 5. Each of the processors may be a single-core (single-CPU) processor, or may be a multi-core (multi-CPU) processor. The processor herein may be one or more devices, circuits, and/or processing cores configured to process data (for example, computer program instructions).

During specific implementation, as an embodiment, the communication apparatus 500 may further include an output device 505 and an input device 506. The output device 505 communicates with the processor 501, and may display information in a plurality of manners.

The communication apparatus 500 may be a general-purpose apparatus or a dedicated apparatus. For example, the communication apparatus 500 may be a desktop computer, a portable computer, a network server, a palmtop computer (personal digital assistant (PDA)), a mobile phone, a tablet computer, a wireless terminal apparatus, an in-vehicle terminal apparatus, an embedded device, or a device having a structure similar to that in FIG. 5. A type of the communication apparatus 500 is not limited in this embodiment of this disclosure.

The following describes, with reference to FIG. 1 to FIG. 5, the time synchronization method provided in embodiments of this disclosure.

FIG. 6 shows a time synchronization method according to an embodiment of this disclosure. The time synchronization method is applied to a distributed camera service scenario, and includes the following steps.

S601: A second device sends a first message to a first device. The first message includes a first time stamp and a second time stamp, the first time stamp is a time stamp of a second WI-FI module in the second device at a first moment, and the second time stamp is a system time stamp of a second main chip in the second device at a second moment. Correspondingly, the first device receives the first message from the second device.

With reference to FIG. 1 or FIG. 2, the first device may be a large screen end, and the second device may be a camera; or the first device may be a camera, and the second device may be a large screen end. This is not limited in this embodiment of this disclosure.

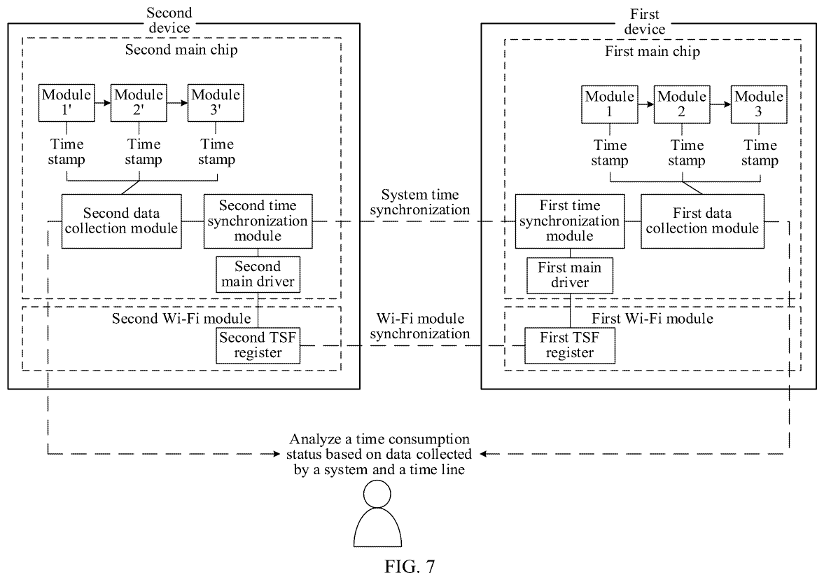

With reference to FIG. 2, FIG. 7 is a diagram of a structure of a communication system according to an embodiment of this disclosure. Compared with FIG. 2, the second device shown in FIG. 7 further has the second WI-FI module, a second time synchronization module, and a second main driver. The second time synchronization module, a second data collection module, the second main driver, and a module 1′, a module 2′, and a module 3′ that are configured to process data are located on the second main chip, and a second timing synchronization function (TSF) register is located in the second WI-FI module. Similarly, compared with FIG. 2, the first device shown in FIG. 7 further has a first WI-FI module, a first time synchronization module, and a first main driver. The first time synchronization module, a first data collection module, the first main driver, and a module 1, a module 2, and a module 3 that are configured to process data are located on a first main chip, and a first TSF register is located in the first WI-FI module.

In this embodiment of this disclosure, the first time synchronization module and the second time synchronization module may be configured to perform system time synchronization between the first device and the second device. The first main driver may be configured to obtain system time of the first device, and the second main driver may be configured to obtain system time of the second device. The first WI-FI module and the second WI-FI module may be configured to perform WI-FI communication between the first device and the second device. The first TSF register and the second TSF register may be configured to perform synchronization between the first WI-FI module and the second WI-FI module. Specific functions of the modules are described in detail in subsequent method embodiments, and details are not described herein.

For example, the first message may include the following packet:

| typedef time_sync_req { | |
|---|---|
| unsigned char ver; | //protocol version number |
| uint64_t sys_time | //system time stamp |
| uint64_t tsf_time | //TSF time stamp |

}

With reference to FIG. 7, in a possible implementation, step S601 may be implemented in the following manner: the second time synchronization module obtains the time stamp of the second WI-FI module from the second TSF register at the first moment, and obtains the system time of the second device from the second main driver at the second moment. Then, the second time synchronization module sends the first message to the first time synchronization module through the second WI-FI module and the first WI-FI module. Correspondingly, the first time synchronization module receives the first message from the second time synchronization module through the first WI-FI module and the second WI-FI module. For example, the second time synchronization module may send the first message to an enhanced distributed channel access (EDCA) high-priority queue of the second WI-FI module, so that the second WI-FI module preferentially sends the first message in the EDCA high-priority queue to the first WI-FI module. Alternatively, the second time synchronization module sends the first message to the first time synchronization module through another communication interface, for example, a network interface on a second time synchronization module side and a network interface on a first time synchronization module side.

S602: The first device adjusts system time of the first main chip in the first device based on the first time stamp, the second time stamp, a third time stamp, and a fourth time stamp. The third time stamp is a time stamp of the first WI-FI module in the first device at a third moment, the fourth time stamp is a system time stamp of the first main chip at a fourth moment, a time difference between the first moment and the second moment is equal to a time difference between the third moment and the fourth moment, and the first WI-FI module and the second WI-FI module have implemented time synchronization before the first moment.

It may be understood that, in this embodiment of this disclosure, a WI-FI connection needs to be established between the first device and the second device, to implement the time synchronization between the first WI-FI module and the second WI-FI module.

In a possible implementation, before step S601, the time synchronization method provided in this embodiment of this disclosure further includes: the second device sends a fifth time stamp to the first device, where the fifth time stamp is a time stamp of the second WI-FI module at a fifth moment, and the fifth moment is earlier than the first moment. Correspondingly, the first device receives the fifth time stamp from the second device, and uses the fifth time stamp as a current time stamp of the first WI-FI module.

In another possible implementation, before step S601, the time synchronization method provided in this embodiment of this disclosure further includes: the first device sends a sixth time stamp to the second device, where the sixth time stamp is a time stamp of the first WI-FI module at a fifth moment. Correspondingly, the second device receives the sixth time stamp from the first device, and uses the sixth time stamp as a current time stamp of the second WI-FI module.

For example, the fifth time stamp or the sixth time stamp in this embodiment of this disclosure may be carried in a beacon frame or a probe response frame. In the processes described in the foregoing two possible implementations, a TSF characteristic of the WI-FI module is used. Because the TSF characteristic of the WI-FI module can implement microsecond-level time synchronization, compared with an NTP protocol used in another technology, this solution can improve time synchronization accuracy.

With reference to FIG. 7, after the first WI-FI module implements time synchronization with the second WI-FI module, a time stamp in the first TSF register is the same as a time stamp in the second TSF register.

In this embodiment of this disclosure, the first device may simultaneously obtain the time stamp of the first WI-FI module and the system time stamp of the first device, and the second device may simultaneously obtain the time stamp of the second WI-FI module and the system time stamp of the second device. Alternatively, the first device may first obtain the time stamp of the first WI-FI module and then obtain the system time stamp of the first device, the second device may first obtain the time stamp of the second WI-FI module and then obtain the system time stamp of the second device, and an interval between the two time stamps obtained by the first device is equal to an interval between the two time stamps obtained by the second device. Alternatively, the first device may first obtain the system time stamp of the first device and then obtain the time stamp of the first WI-FI module, the second device may first obtain the system time stamp of the second device and then obtain the time stamp of the second WI-FI module, and an interval between the two time stamps obtained by the first device is equal to an interval between the two time stamps obtained by the second device. In other words, a rule for obtaining the time stamp of the first WI-FI module and the system time stamp of the first device by the first device is consistent with a rule for obtaining the time stamp of the second WI-FI module and the system time stamp of the second device by the second device.

With reference to FIG. 7, optionally, before the first device adjusts the system time of the first main chip, the synchronization method provided in this embodiment of this disclosure may further include: the first time synchronization module obtains the time stamp of the first WI-FI module from the first TSF register at the third moment, and obtains the system time of the first device from the first main driver at the fourth moment.

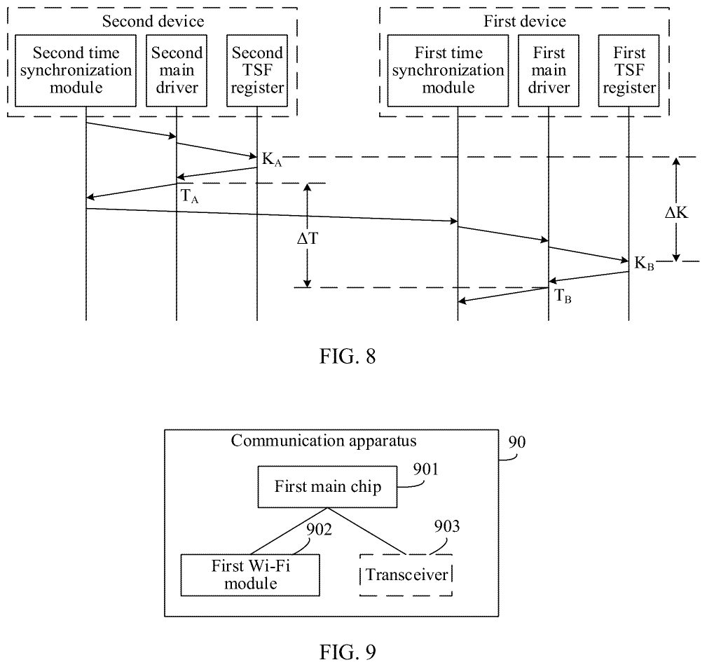

With reference to FIG. 7, for example, FIG. 8 shows a time stamp obtaining manner. K_{A} represents the time stamp of the second WI-FI module at the first moment, T_{A} represents the system time stamp of the second device at the second moment, K_{B} represents the time stamp of the first WI-FI module at the third moment, T_{B} represents the system time stamp of the first device at the fourth moment, ΔT is a difference between T_{B} and T_{A}, and ΔK is a difference between K_{B} and K_{A}. Because the system time of the first device may be slower than or faster than the system time of the second device, or the system time of the first device may have been synchronized with the system time of the second device, ΔT may be zero, a positive number, or a negative number. However, because the first TSF register and the second TSF register have implemented time synchronization before the first moment, and the first moment is earlier than the third moment, a value of ΔK is positive. In the time stamp obtaining manner shown in FIG. 8, the second time synchronization module first obtains the time stamp K_{A} of the second WI-FI module and then obtains the system time stamp T_{A} of the second device, the first time synchronization module first obtains the time stamp K_{B} of the first WI-FI module and then obtains the system time stamp T_{B} of the first device, and an interval between K_{A} and T_{A} that are obtained by the second time synchronization module is equal to an interval between K_{B} and T_{B} that are obtained by the first time synchronization module.

In a possible implementation, in this embodiment of this disclosure, that the first device adjusts the system time of the first main chip in the first device based on the first time stamp, the second time stamp, a third time stamp, and a fourth time stamp includes: the first device determines, based on the first time stamp, the second time stamp, the third time stamp, and the fourth time stamp, deviation time of system time of the first device relative to the system time of the second device; and if an absolute value of the deviation time is greater than a first threshold, the first device adds the deviation time to current system time, to obtain synchronized current system time of the first main chip. In this solution, the system time of the second device is used as a reference, and if there is a deviation between the system time of the first device and the system time of the second device and an absolute value of the deviation is greater than the first threshold, the system time of the first device is adjusted.

Optionally, the first device may feed back, to the second device, whether time synchronization succeeds. With reference to FIG. 7, a feedback process may be implemented by the first time synchronization module and the second time synchronization module. If the first time synchronization module successfully determines the deviation time of the system time of the first device relative to the system time of the second device, it may mean that the first time synchronization module succeeds in system time synchronization. For example, a feedback message may include the following packet:

typedef time_sync_reply {
unsigned char ver; //protocol version number
unsigned char status //synchronization status value: 0 success, <0 failure
}

Optionally, the deviation time is a difference obtained by subtracting a second time difference from a first time difference, the first time difference is a difference obtained by subtracting the second time stamp from the fourth time stamp, and the second time difference is a difference obtained by subtracting the first time stamp from the third time stamp.

With reference to FIG. 8, the deviation time may be represented as (T_{B}−T_{A})−(K_{B}−K_{A})=ΔT−ΔK. The deviation time may be zero, a positive number, or a negative number.

In a possible implementation, in this embodiment of this disclosure, the first device adds the deviation time to a system time stamp that is of the first main chip and that is collected before a current moment, to obtain a synchronized system time stamp that is of the first main chip and that is collected before the current moment. In this solution, system time synchronization may occur before data collection or during data collection, so that time synchronization flexibility can be improved. If system time synchronization occurs before data collection, the first device may correct the system time of the first device, so that data collected by the first device and data collected by the second device are subsequently based on a same time standard. If system time synchronization occurs during data collection, the first device may correct collected time data and the system time of the first device.

In the time synchronization method provided in this embodiment of this disclosure, after the first WI-FI module and the second WI-FI module implement time synchronization, the first device adjusts the system time of the first main chip in the first device based on the first time stamp, the second time stamp, the third time stamp, and the fourth time stamp. Compared with an NTP protocol used in another technology, on one hand, because of occupying less system resources and causing lower device power consumption, a WI-FI protocol may be widely applied to an IoT device. Therefore, the time synchronization method provided in this embodiment of this disclosure is more applicable to the distributed camera service scenario. On the other hand, because WI-FI module time synchronization between the first device and the second device can be implemented at a microsecond level, the time synchronization method provided in this embodiment of this disclosure can improve time synchronization accuracy.

Both the first device and the second device in the foregoing embodiments may use the architecture of the communication apparatus 500 shown in FIG. 5. Therefore, the processor 501 in the communication apparatus 500 shown in FIG. 5 may invoke application program code stored in the memory 503, to instruct the first device to perform the actions of the first device in the foregoing embodiments, and the processor 501 in the communication apparatus 500 shown in FIG. 5 may invoke application program code stored in the memory 503, to instruct the second device to perform the actions of the second device in the foregoing embodiments. This is not limited in embodiments.

It may be understood that, in the foregoing embodiments, the method and/or the step implemented by the first device may alternatively be implemented by a component (for example, a chip or a circuit) that can be used for the first device, and the method and/or the step implemented by the second device may alternatively be implemented by a component (for example, a chip or a circuit) that can be used for the second device.

The foregoing mainly describes the solutions provided in embodiments of this disclosure from a perspective of interaction between network elements. Correspondingly, an embodiment of this disclosure further provides a communication apparatus, and the communication apparatus is configured to implement the foregoing various methods. The communication apparatus may be the first device in the foregoing method embodiments, an apparatus including the foregoing first device, or a component that can be used for the first device; or the communication apparatus may be the second device in the foregoing method embodiments, an apparatus including the foregoing second device, or a component that can be used for the second device. It may be understood that, to implement the foregoing functions, the communication apparatus includes corresponding hardware structures and/or software modules for performing the functions. A person skilled in the art should easily be aware that, in combination with units and algorithm steps of the examples described in embodiments disclosed in this specification, this disclosure can be implemented by hardware or a combination of hardware and computer software. Whether a function is performed by hardware or hardware driven by computer software depends on particular applications and design constraint conditions of the technical solutions. A person skilled in the art may use different methods to implement the described functions for each particular application, but it should not be considered that the implementation goes beyond the scope of this disclosure.

In embodiments of this disclosure, the communication apparatus may be divided into functional modules based on the foregoing method embodiments. For example, functional modules may be obtained through division based on corresponding functions, or two or more functions may be integrated into one processing module. The integrated module may be implemented in a form of hardware, or may be implemented in a form of a software functional module. It should be noted that, in embodiments of this disclosure, module division is an example, and is merely logical function division. During actual implementation, another division manner may be used.

FIG. 9 is a diagram of a structure of a communication apparatus 90. The communication apparatus 90 includes a first main chip 901 and a first WI-FI module 902. Optionally, the communication apparatus 90 further includes a transceiver 903. The transceiver 903 may also be referred to as a transceiver unit, configured to implement a transceiver function, for example, may be a transceiver circuit, a transceiver, or a communication interface.

For example, the communication apparatus 90 is the first device in the foregoing method embodiments.

The first main chip 901 is configured to receive a first message from a second device, where the first message includes a first time stamp and a second time stamp, the first time stamp is a time stamp of a second WI-FI module in the second device at a first moment, and the second time stamp is a system time stamp of a second main chip in the second device at a second moment. The first main chip 901 is further configured to adjust system time of the first main chip 901 in the communication apparatus 90 based on the first time stamp, the second time stamp, a third time stamp, and a fourth time stamp, where the third time stamp is a time stamp of the first WI-FI module 902 at a third moment, the fourth time stamp is a system time stamp of the first main chip 901 at a fourth moment, a time difference between the first moment and the second moment is equal to a time difference between the third moment and the fourth moment, and the first WI-FI module 902 and the second WI-FI module have implemented time synchronization before the first moment.

In a possible implementation, the first WI-FI module 902 is configured to receive a fifth time stamp from the second device, where the fifth time stamp is a time stamp of the second WI-FI module at a fifth moment, and the fifth moment is earlier than the first moment; and the first WI-FI module 902 is further configured to use the fifth time stamp as a current time stamp of the first WI-FI module 902; or the first WI-FI module 902 is configured to send a sixth time stamp to the second device, where the sixth time stamp is a time stamp of the first WI-FI module 902 at the fifth moment.

In a possible implementation, the first main chip 901 is configured to: determine, based on the first time stamp, the second time stamp, the third time stamp, and the fourth time stamp, deviation time of system time of the communication apparatus 90 relative to system time of the second device; and if an absolute value of the deviation time is greater than a first threshold, add the deviation time to current system time, to obtain synchronized current system time of the first main chip 901.

In a possible implementation, the deviation time is a difference obtained by subtracting a second time difference from a first time difference, the first time difference is a difference obtained by subtracting the second time stamp from the fourth time stamp, and the second time difference is a difference obtained by subtracting the first time stamp from the third time stamp.

In a possible implementation, the first main chip 901 is further configured to add the deviation time to a system time stamp that is of the first main chip 901 and that is collected before a current moment, to obtain a synchronized system time stamp that is of the first main chip 901 and that is collected before the current moment.

In a possible implementation, that the first main chip 901 is configured to receive a first message from a second device includes: the first main chip 901 is configured to receive the first message from the second device through the first WI-FI module 902.

In a possible implementation, that the first main chip 901 is configured to receive a first message from a second device includes: the first main chip 901 is configured to receive the first message from the second device through the transceiver 903.

All related content of the steps in the foregoing method embodiments may be cited in function descriptions of the corresponding functional modules. Details are not described herein again.

In this embodiment, the communication apparatus 90 is presented in a form of functional modules obtained through division in an integrated manner. The “module” herein may be an ASIC, a circuit, a processor that executes one or more software or firmware programs, a memory, an integrated logic circuit, and/or another device capable of providing the foregoing function.

When the communication apparatus 90 is the first device or the second device in the foregoing method embodiments, in a simple embodiment, a person skilled in the art may figure out that the communication apparatus 90 may be in a form of the communication apparatus 500 shown in FIG. 5.

For example, the processor 501 or 507 in the communication apparatus 500 shown in FIG. 5 may invoke computer-executable instructions stored in the memory 503, to enable the communication apparatus 500 to perform the time synchronization method in the foregoing method embodiments. The function/implementation process of the first main chip 901 in FIG. 9 may be implemented by the processor 501 or 507 in the communication apparatus 500 shown in FIG. 5 by invoking computer-executable instructions stored in the memory 503. The function/implementation process of the first WI-FI module 902 or the transceiver 903 in FIG. 9 may be implemented through a communication module connected to the communication interface 504 in FIG. 5.

Because the communication apparatus 90 provided in this embodiment can perform the foregoing time synchronization method, for technical effects that can be achieved by the communication apparatus 90, refer to the foregoing method embodiments. Details are not described herein again.

It should be noted that one or more of the foregoing modules or units may be implemented by software, hardware, or a combination thereof. When any one of the foregoing modules or units is implemented by software, the software exists in a form of computer program instructions, and is stored in the memory. The processor may be configured to execute the program instructions and implement the foregoing method procedures. The processor may be built into a system on chip (SoC) or an ASIC, or may be an independent semiconductor chip. In addition to a core configured to perform computing or processing by executing software instructions, the processor may further include a necessary hardware accelerator, for example, a field-programmable gate array (FPGA), a programmable logic device (PLD), or a logic circuit that implements a dedicated logic operation.

When the foregoing modules or units are implemented by hardware, the hardware may be any one or any combination of a CPU, a microprocessor, a digital signal processing (DSP) chip, a micro control unit (MCU), an artificial intelligence processor, an ASIC, a SoC, an FPGA, a PLD, a dedicated digital circuit, a hardware accelerator, or a non-integrated discrete device, and the hardware may run necessary software or does not depend on software to perform the foregoing method procedures.

Optionally, an embodiment of this disclosure further provides a chip system, including at least one processor and an interface. The at least one processor is coupled to a memory through the interface, and when the at least one processor executes a computer program or instructions in the memory, the method in any one of the foregoing method embodiments is performed. In a possible implementation, the communication apparatus further includes the memory. Optionally, the chip system may include a chip, or may include a chip and another discrete device. This is not limited in this embodiment of this disclosure.

All or some of the foregoing embodiments may be implemented by software, hardware, firmware, or any combination thereof. When the foregoing embodiments are implemented by using a software program, all or some of the foregoing embodiments may be implemented in a form of a computer program product. The computer program product includes one or more computer instructions. When the computer program instructions are loaded and executed on a computer, all or some of the procedures or functions according to embodiments of this disclosure are generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a digital versatile disc (DVD)), a semiconductor medium (for example, a solid state disk (SSD)), or the like.

Although this disclosure is described with reference to embodiments, in a process of implementing this disclosure that claims protection, a person skilled in the art may understand and implement other variations of the disclosed embodiments by viewing the accompanying drawings, disclosed content, and appended claims. In the claims, the word “comprising” does not exclude another component or step, and “a” or “one” does not exclude a case of “a plurality of”. A single processor or another unit may implement several functions enumerated in the claims. Some measures are recorded in dependent claims that are different from each other, but this does not mean that these measures cannot be combined to produce a better effect.

Although this disclosure is described with reference to specific features and embodiments thereof, it is clear that various modifications and combinations may be made to this disclosure without departing from the spirit and scope of this disclosure. Correspondingly, the specification and accompanying drawings are merely example descriptions of this disclosure defined by the accompanying claims, and are considered as covering any one or all of modifications, variations, combinations, or equivalents in the scope of this disclosure. It is clear that a person skilled in the art can make various modifications and variations to this disclosure without departing from the spirit and scope of this disclosure. In this way, this disclosure is also intended to include these modifications and variations to this disclosure provided that they fall within the scope of the claims of this disclosure and equivalent technologies thereof.

What is claimed is:

1. A method, comprising:
receiving, by a first device and from a second device, a first message comprising a first time stamp and a second time stamp, wherein the first time stamp is of a second WI-FI component in the second device at a first moment, and wherein the second time stamp is a system time stamp of a second main chip in the second device at a second moment; and
adjusting, by the first device and based on the first time stamp, the second time stamp, a third time stamp, and a fourth time stamp, a first system time of a first main chip in the first device,
wherein the third time stamp is of a first WI-FI component in the first device at a third moment,
wherein the fourth time stamp is of the first main chip at a fourth moment, and
wherein a first time difference between the first moment and the second moment is equal to a second time difference between the third moment and the fourth moment.

2. The method of claim 1, wherein before receiving the first message, the method further comprises:
receiving, by the first device and from the second device, a fifth time stamp, wherein the fifth time stamp is of the second WI-FI component at a fifth moment, and wherein the fifth moment is earlier than the first moment; and
either:
using, by the first device, the fifth time stamp as a current time stamp of the first WI-FI component; or
sending, by the first device and to the second device, a sixth time stamp, wherein the sixth time stamp is of the first WI-FI component at the fifth moment.

3. The method of claim 1, wherein adjusting the first system time comprises:
determining, by the first device and based on the first time stamp, the second time stamp, the third time stamp, and the fourth time stamp, a deviation time of a second system time of the first device relative to a third system time of the second device; and
adding, by the first device and when an absolute value of the deviation time is greater than a first threshold, the deviation time to a current system time to obtain a synchronized current system time of the first main chip.

4. The method of claim 3, further comprising:
subtracting the second time stamp from the fourth time stamp to obtain the first time difference;
subtracting the first time stamp from the third time stamp to obtain the second time difference; and
subtracting the second time difference from the first time difference to obtain the deviation time.

5. The method of claim 3, further comprising adding, by the first device, the deviation time to a system time stamp that is of the first main chip and that is collected before a current moment to obtain a synchronized system time stamp of the first main chip.

6. An apparatus, comprising:
a first WI-FI component; and
a first main chip configured to:
receive, from a second device, a first message comprising a first time stamp and a second time stamp, wherein the first time stamp is of a second WI-FI component in the second device at a first moment, and wherein the second time stamp is a system time stamp of a second main chip in the second device at a second moment; and
adjust, based on the first time stamp, the second time stamp, a third time stamp, and a fourth time stamp, a first system time of the first main chip,
wherein the third time stamp is of the first WI-FI component at a third moment,
wherein the fourth time stamp is of the first main chip at a fourth moment,
wherein a first time difference between the first moment and the second moment is equal to a second time difference between the third moment and the fourth moment, and
wherein the first WI-FI component and the second WI-FI component implemented time synchronization before the first moment.

7. The apparatus of claim 6, wherein the first WI-FI component is configured to:
receive, from the second device, a fifth time stamp of the second WI-FI component at a fifth moment, wherein the fifth moment is earlier than the first moment; and
either:
use the fifth time stamp as a current time stamp of the first WI-FI component; or
send, to the second device, a sixth time stamp of the first WI-FI component at the fifth moment.

8. The apparatus of claim 6, wherein the first main chip is further configured to:
determine, based on the first time stamp, the second time stamp, the third time stamp, and the fourth time stamp, a deviation time of a second system time of the apparatus relative to a third system time of the second device; and
add, when an absolute value of the deviation time is greater than a first threshold, the deviation time to a current system time to obtain a synchronized current system time of the first main chip.

9. The apparatus of claim 8, wherein the first main chip is further configured to:
subtract the second time stamp from the fourth time stamp to obtain the first time difference;
subtract the first time stamp from the third time stamp to obtain the second time difference; and
subtract the second time difference from the first time difference to obtain the deviation time.

10. The apparatus of claim 8, wherein the first main chip is further configured to add the deviation time to a system time stamp that is of the first main chip and that is collected before a current moment to obtain a synchronized system time stamp of the first main chip.

11. The apparatus of claim 6, wherein the first main chip is further configured to receive, through the first WI-FI component, the first message.

12. The apparatus of claim 6, further comprising a transceiver coupled to the first main chip, and wherein the first main chip is further configured to receive, through the transceiver, the first message.

13. A first device, comprising:
a memory configured to store instructions; and
one or more processors coupled to the memory and configured to execute the instructions to:
receive, from a second device, a first message comprising a first time stamp and a second time stamp, wherein the first time stamp is of a second WI-FI component in the second device at a first moment, and wherein the second time stamp is a system time stamp of a second main chip in the second device at a second moment; and
adjust, based on the first time stamp, the second time stamp, a third time stamp, and a fourth time stamp, a first system time of a first main chip in the first device, wherein the third time stamp is of a first WI-FI component in the first device at a third moment,
wherein the fourth time stamp is of the first main chip at a fourth moment, and
wherein a first time difference between the first moment and the second moment is equal to a second time difference between the third moment and the fourth moment.

14. The first device of claim 13, wherein the one or more processors are further configured to execute the instructions to:
receive, from the second device, a fifth time stamp of the second WI-FI component at a fifth moment, wherein the fifth moment is earlier than the first moment; and
either:
use the fifth time stamp as a current time stamp of the first WI-FI component; or
send, to the second device, a sixth time stamp of the first WI-FI component at the fifth moment.

15. The first device of claim 13, wherein the one or more processors are further configured to execute the instructions to:
determine, based on the first time stamp, the second time stamp, the third time stamp, and the fourth time stamp, a deviation time of a second system time of the first device relative to a third system time of the second device; and
add, when an absolute value of the deviation time is greater than a first threshold, the deviation time to a current system time to obtain a synchronized current system time of the first main chip.

16. The first device of claim 15, wherein the one or more processors are further configured to execute the instructions to:
subtract the second time stamp from the fourth time stamp to obtain the first time difference;
subtract the first time stamp from the third time stamp to obtain the second time difference; and
subtract the second time difference from the first time difference to obtain the deviation time.

17. The first device of claim 15, wherein the one or more processors are further configured to execute the instructions to add the deviation time to a system time stamp that is of the first main chip and that is collected before a current moment to obtain a synchronized system time stamp of the first main chip.

18. The first device of claim 13, wherein the first device comprises an Internet of things (IoT) device.

19. The first device of claim 13, wherein the first device is configured to be implemented in a distributed camera service system.

20. The first device of claim 13, wherein the first message further comprises a protocol version number.
